(19) United States
(12) Patent Application Publication
(10) Pub. No.: US 2025/0245724 A1
(43) Pub. Date: Jul. 31, 2025

(54) SYSTEMS AND METHODS FOR INFORMATION RECOMMENDATION BASED ON COLLABORATIVE FILTERING

(71) Applicant: Walmart Apollo, LLC, Bentonville, AR (US)

(72) Inventors: Abhinav Prakash, Milpitas, CA (US); Akash Daxeshkumar Patel, Sunnyvale, CA (US); Yokila Arora, San Jose, CA (US); Hyun Duk Cho, San Francisco, CA (US); Sushant Kumar, San Jose, CA (US); Kannan Achan, Saratoga, CA (US)

(21) Appl. No.: 19/012,417

(22) Filed: Jan. 7, 2025

Related U.S. Application Data
(60) Provisional application No. 63/627,304, filed on Jan. 31, 2024.

(51) Int. Cl. G06Q 30/0601; G06F 16/9536; G06Q 30/0201

(52) U.S. Cl. CPC G06Q 30/0631; G06F 16/9536; G06Q 30/0201; G06Q 30/0643

(57) ABSTRACT

This application is directed to systems and methods for information recommendation and/or ranking. In some embodiments, a disclosed method includes obtaining a request to select a set of personalized items in a collection of information items to a user; identifying a subset of a plurality of users that are classified to a first user class and includes the user; identifying a subset of a collection of information items that are classified to a first object class having a predefined relationship with the first object class; applying a collaborative filtering model to identify one or more personalized information items in the subset of information items based on engagement information of the subset of users with the subset of information items; and in response to the request, enabling display of the one or more information items on a screen of a client device associated with the user.

### RELATED APPLICATION

This application claims benefits of U.S. Provisional Application No. 63/627,304, filed Jan. 31, 2024, titled “Systems and Methods for Information Recommendation Based on Collaborative Filtering,” which is incorporated by reference in its entirety.

### TECHNICAL FIELD

This application relates generally to information processing and, more particularly, to systems and methods for recommending information items based on collaborative filtering.

### BACKGROUND

Cloud-based service platforms oftentimes provide data items representative of information in response to a user action (e.g., provide information of related products in response to a user's action of adding a particular product into a shopping cart). These data items are normally ranked to enhance visibility and accessibility of the data items to potential customers, thereby improving user engagement (e.g., orders, clicks for review). The user's interactions are recorded to track user engagement and become valuable resources that provide information about additional data items that can be recommended to the user. The user's own engagement information only encompasses information of a limited number of data items and may be related to items that are no longer of interest to a user. The limited dataset and/or inclusion of extraneous items compromises an engagement level of the products associated with additional data items identified for the individual users.

### SUMMARY

In various embodiments, a system including a non-transitory memory configured to store instructions thereon and at least one processor is disclosed. The at least one processor is configured to identify a request to recommend one or more information items in a collection of information items to a user and determine that the user belongs to a first user class of a plurality of user classes and that the first user class has a predefined relationship with a first object class of a plurality of object classes. The at least one processor is further configured to identify, among a plurality of users, a subset of users that are classified to the first user class, the subset of users including the user and identify, in the collection of information items, a subset of information items that are classified to the first object class. The at least one processor is further configured to apply a collaborative filtering model to identify the one or more information items in the subset of information items based on engagement information of the subset of users, who belong to the first user class associated with the user, with the subset of information items. The at least one processor is further configured to in response to the request, enable display of the one or more information items on a screen of a client device associated with the user.

In various embodiments, a computer-implemented method is disclosed. The computer-implemented method includes a step of obtaining a request to recommend one or more personalized information items in a collection of information items to a user. The computer-implemented method further includes steps of determining that the user belongs to a first user class of a plurality of user classes and that the first user class has a predefined relationship with a first object class of a plurality of object classes; identifying, among a plurality of users, a subset of users that are classified to the first user class, the subset of users including the user; and identifying, in the collection of information items, a subset of information items that are classified to the first object class. The computer-implemented method further includes steps of applying a collaborative filtering model to identify one or more personalized information items in the subset of information items based on engagement information of the subset of users, who belong to the first user class associated with the user, with the subset of information items. The computer-implemented method further includes steps of in response to identifying the one or more personalized information items, generating instructions configured to display an interface including the one or more personalized information items on a client device associated with the user.

In various embodiments, a non-transitory computer readable medium having instructions stored thereon is disclosed. The instructions, when executed by at least one processor, cause at least one device to perform operations including obtaining a request to recommend a set of personalized information items in a collection of information items to a user; determining that the user belongs to a first user class of a plurality of user classes and that the first user class has a predefined relationship with a first object class of a plurality of object classes; identifying, among a plurality of users, a subset of users that are classified to the first user class, the subset of users including the user; identifying, in the collection of information items, a subset of information items that are classified to the first object class; applying a collaborative filtering model to identify one or more information items in the subset of information items based on engagement information of the subset of users, who belong to the first user class associated with the user, with the subset of information items; and in response to identifying the one or more personalized information items, generating instructions configured to display an interface including the one or more personalized information items on a client device associated with the user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of tenants, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8 is a flow diagram of an example process of recommending and ranking information items using a collaborative filtering model, in accordance with some embodiments;

FIG. 9 is a block diagram of a system for generating information item recommendations using a user object engine, in accordance with some embodiments;

FIGS. 10A-10C are example user interfaces of a user application, in accordance with some embodiments;

FIGS. 11A-11D are user interfaces that present a vehicle profile for a user, in accordance with some embodiments;

FIGS. 12A and 12B are user interfaces that display a transaction history of a user identified with a first class and a set of recommended information items, in accordance with some embodiments, respectively;

FIGS. 13A and 13B are user interfaces that display a transaction history of a user identified with a second class and a set of recommended information items, in accordance with some embodiments, respectively; and

FIG. 14 is a flowchart illustrating an example method for information recommendation, ranking, and/or presentation, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for recommending, ranking, and/or presenting information items associated with a set of data objects (e.g., data objects representative of items, products, etc.) based on similar users' engagement with the set of data objects on a cloud-based service platform. The similar users include a set of users classified to one of a plurality of user classes and to which the information items have been recommended and presented. One or more trained models are configured to understand both the user to whom the information items are recommended and data objects that are available for recommendation. For example, a trained model (e.g., a user classifier) may be applied to classify a user to whom the information items are recommended into a first user class of a plurality of user classes and a second trained model (e.g., an object classifier) may be applied to classify a plurality of available data objects into a plurality of object classes. The plurality of object classes may include a first object class associated with the first user class, e.g., where both are related to a one or more common elements (e.g., each being related to a pet type (e.g., pet owner and pet-related object) such as cats, dogs, birds, or horses).

In some embodiments, a user understanding confidence score is determined for each object class based on associated user engagement features. A set of objects may be identified based on engagement information of a set of users associated with the first object class using a collaborative filtering model. An output of the collaborative filtering model may allow formation of personalized recommendations of information items for a user of a first user class associated with the first object class. Information items having a higher relevance, as compared to existing recommendation systems, are identified for each individual user based on similar users' engagement information. Such personalized recommendations may be provided to enhance an engagement level of the user, especially when information associated with a large number of similar users is accessible to provide relevant engagement information and when millions of information items associated with a large number of associated products are available for selection.

In some embodiments, an end-to-end framework configured to understand candidate information items available for recommendation and presentation, thereby enhancing user experience on the cloud-based service platform. The framework may develop a novel ensemble learning model, comprising of multiple weak learner models, to associate a large number of information items (e.g., associated with >25 million information items) with a plurality of object classes (e.g., objects associated with pet types such as dog, cat, bird, horse, etc.) in a highly computation-efficient manner. Additionally, the framework may include a user classifier model and a collaborative filtering model. A user classifier model may be configured to generate one or more probability scores (e.g., confidence scores) each indicating a probability of a user belonging to a respective user class (e.g., a user being a dog owner). The collaborative filtering model may be trained to derive user embeddings for similar users and object embeddings for the information items. The user embeddings may be further applied to determine personalized recommendations for the corresponding user.

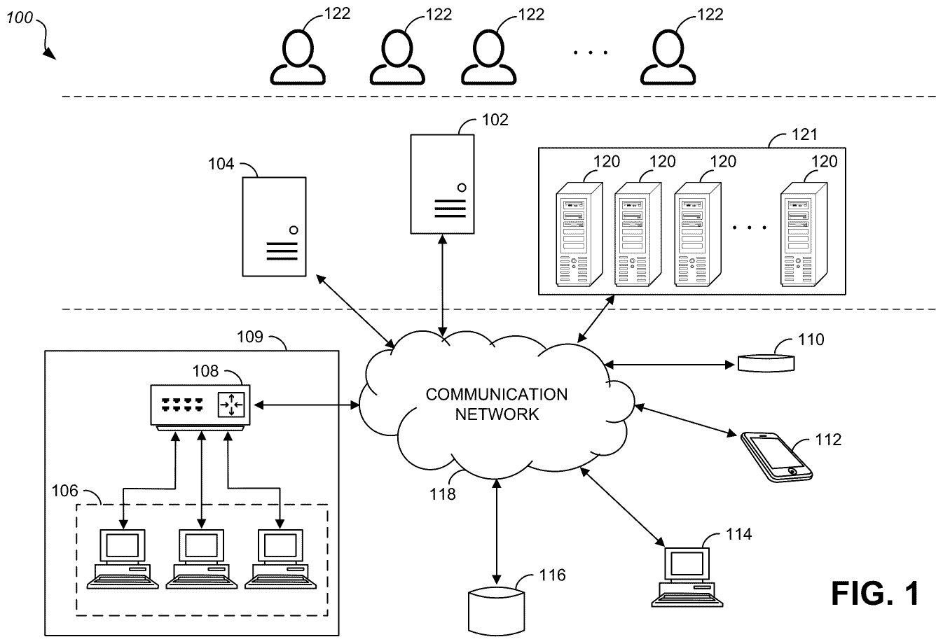

FIG. 1 is a network environment configured to provide a user application (e.g., a network interface application, an online shopping application, etc.) to a plurality of tenants, in accordance with some embodiments. The network environment 100 includes a plurality of devices or systems configured to communicate over one or more network channels, illustrated as a network cloud 118. For example, in various embodiments, the network environment 100 can include, but is not limited to, a recommendation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation computing device 102.

In some examples, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the recommendation computing device 102, the processing devices 120, and/or the web server 104 are operated by a network environment provider, and the multiple user computing devices 110, 112, 114 are operated by users 122 of the network environment. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the recommendation computing device 102 over the communication network 118. The workstation(s) 106 may send data to, and receive data from, the recommendation computing device 102.

Although FIG. 1 illustrates three user computing devices 110, 112, 114, the network environment 100 can include any number of user computing devices 110, 112, 114. Similarly, the network environment 100 can include any number of the recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the recommendation computing device 102 over the communication network 118.

In some examples, the recommendation computing device 102 may execute one or more models, such as a trained classifier, a collaborative filtering model, a feature extraction model, etc., to identify one or more information items for a user of a first user class among a set of information items of a particular object class based on engagement of other users of the first user class with the set of information items. The recommendation computing device 102 may transmit the one or more identified information items to the web server 104 over the communication network 118, and the web server 104 may present the one or more identified information items on a screen of an electronic device associated with the user.

The recommendation computing device 102 is further operable to communicate with the database 116 over the communication network 118. For example, the recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation computing device 102, in some examples, the database 116 can be a local storage device, such as a hard drive, a non-volatile memory, or a USB stick. The recommendation computing device 102 may store purchase data received from the web server 104 in the database 116. The recommendation computing device 102 may also receive from the web server 104 user session data identifying events associated with browsing sessions, and may store the user session data in the database 116.

In some examples, the recommendation computing device 102 generates training data for a plurality of models (e.g., user engagement extraction model, classification model or classifier, collaborative filtering model, etc.) based on image data, historical user session data, etc. The recommendation computing device 102 may train the models based on their corresponding training data and may store the models in a database, such as in the database 116 (e.g., a cloud storage).

The models, when executed by the recommendation computing device 102, allow the recommendation computing device 102 to recommend and rank interface elements related to information items to be displayed to a user 122. For example, the recommendation computing device 102 may obtain the models from the database 116. The recommendation computing device 102 may then execute the models to identify, among a plurality of users, a subset of users that are classified in a first user class associated with a specific user. The recommendation computing device 102 may further execute the models to identify, in a collection of information items, a subset of information items that are classified in a first object class associated with the first user class and identify one or more information items for the specific user in the subset of information items based on engagement information of the subset of users with the subset of information items.

In some embodiments, the recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, recommendation computing device 102 may generate ranked item recommendations for items to be displayed on the website to a user.

In some embodiments, the network environment 100 is configured to provide a user application (e.g., a network interface application, an online shopping application, etc.) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple customer computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item recommendation requests) are received from the workstation(s) 106 and customer computing devices 110, 112 and 114.

The network environment 100 is implemented to enable secure concurrent access experience by multiple users 122 of the user application. User interactions (e.g., queries, actions, etc.) of the plurality of users 122 are managed in a centralized manner by the recommendation computing device 102 and/or the cloud-based engine 121. In some embodiments, the recommendation computing device 102 and/or the cloud-based engine 121 identifies a request to recommend one or more information items in a collection of information items to a user. The recommendation computing device further determines that the user belongs to a first user class of a plurality of user classes and that the first user class has a predefined relationship with a first object class of a plurality of object classes. The recommendation computing device 102 and/or the cloud-based engine 121 identifies a subset of users classified to the first user class among a plurality of users and a subset of information items classified to the first object class in the collection of information items. The subset of users may include the user associated with the request. A collaborative filtering model is applied to identify one or more information items for recommendation in the subset of information items based on engagement information of the subset of users belonging to the first user class. Stated another way, in accordance with engagement of other similar users (e.g., users belonging to the same user class) with the subset of information items, the recommendation computing device 102 and/or the cloud-based engine 121 identifies one or more information items having a higher chance of engagement by the user as compared to a remainder of the subset of information items. In response to the request, the recommendation computing device 102 and/or the cloud-based engine 121 enables display of interface elements representative of the one or more information items on a screen of a client device (e.g., one or more user computing devices 110, 112, 114 in FIG. 1) associated with the user. The recommendation computing device 102 and/or the cloud-based engine 121 may identify relevant information items based on similar users' engagement histories to recommended information items to a specific user belonging to the same user class in an effective and efficient manner.

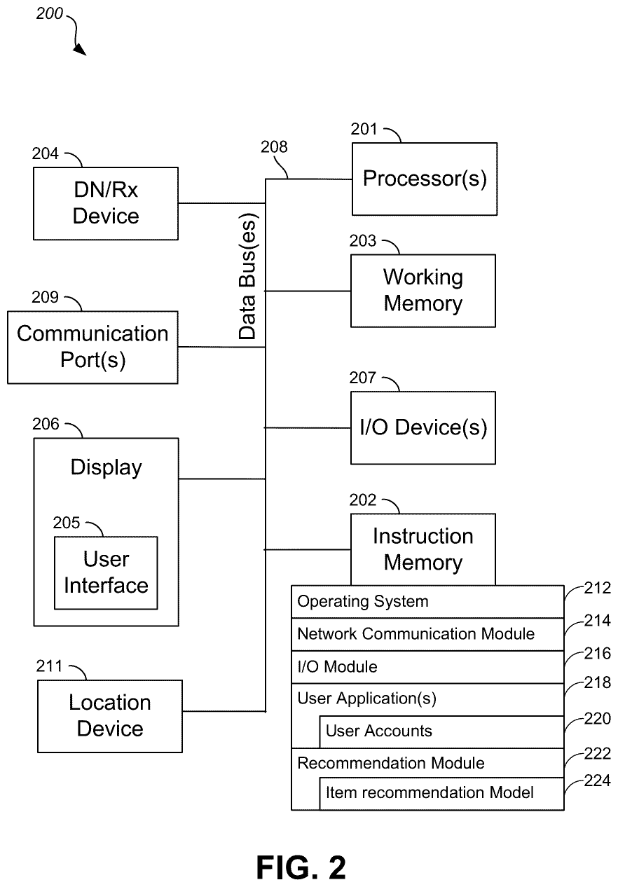

FIG. 2 is a block diagram of a computing device 200, in accordance with some embodiments of the present teaching. In some embodiments, each of the recommendation computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the recommendation computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the recommendation computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the recommendation computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the recommendation computing device 102 may determine a local geographical area (e.g., town, city, state, etc.) of its position.

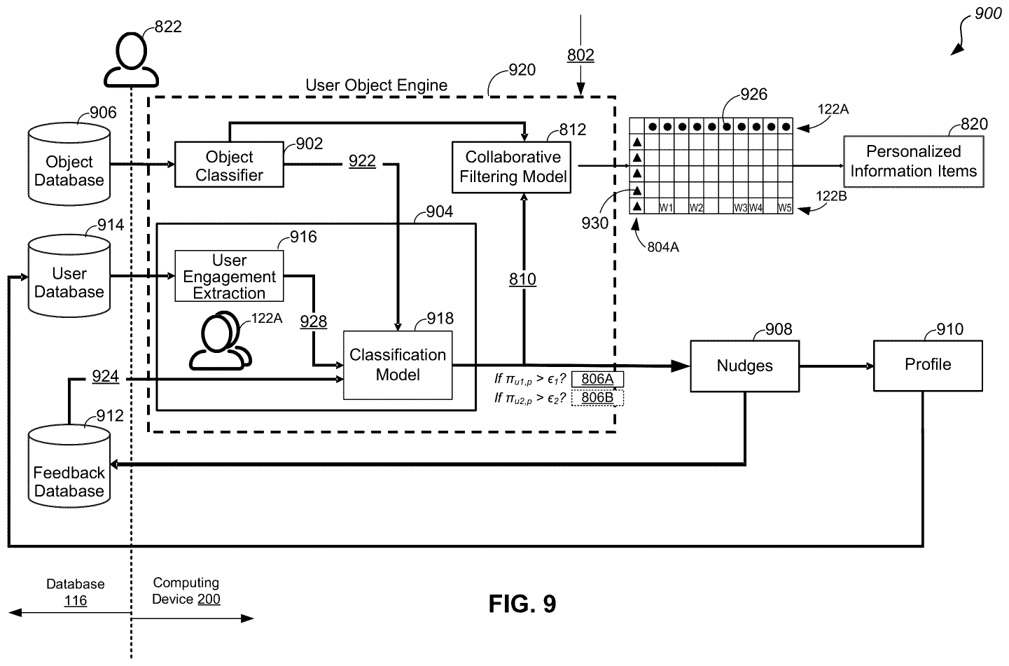

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is an online shopping application having a plurality of user accounts 220 associated with a plurality of users 122; and
Recommendation module 222 that is executed to identify one or more information items in a set of information items for a user of a first user class based on information describing engagement of a set of similar users of the first user class with the set of information items, which belong to a first object class associated with the first user class, where in some embodiments, an item recommendation model 224 (e.g., a combination of an object classifier 902, a user classifier 904, and a collaborative filtering model 812 in FIG. 9) is applied to determine the recommended information items from millions of information items on a cloud-based service platform.

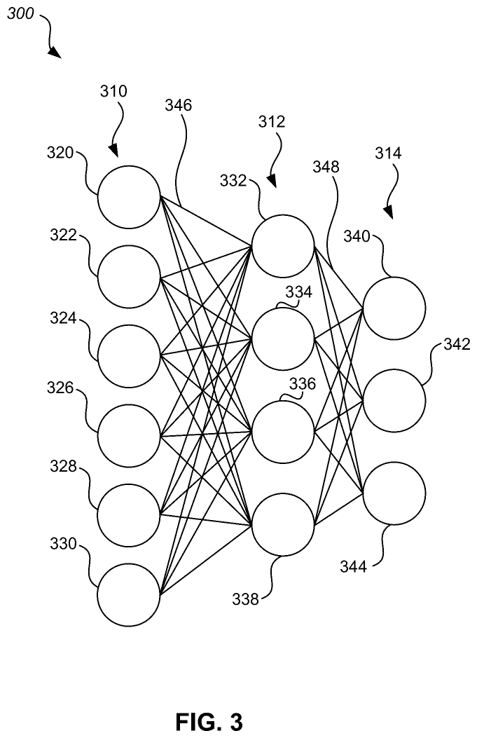

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ⁽ⁿ⁾ denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}⁽ⁿ⁾ is defined for the weight w_{i,j}^{(n,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by

$${x}_{j}^{( n + 1 )} = f ( {\sum }_{i} {x}_{i}^{( n )} \cdot {w}_{i , j}^{( n )} ) \qquad ( 1 )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 2 )$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} ) \qquad ( 3 )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} ) \qquad ( 4 )$$

if the (n+1)-th layer is the output layer 34, wherein f is the first derivative of the activation function, and γⱼ⁽ⁿ⁺¹⁾ is the comparison training value for the j-th node of the output layer 314.

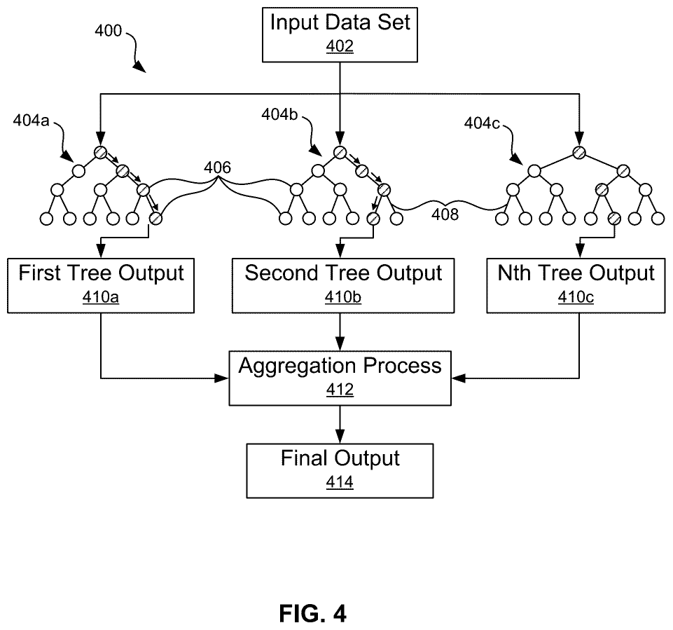

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

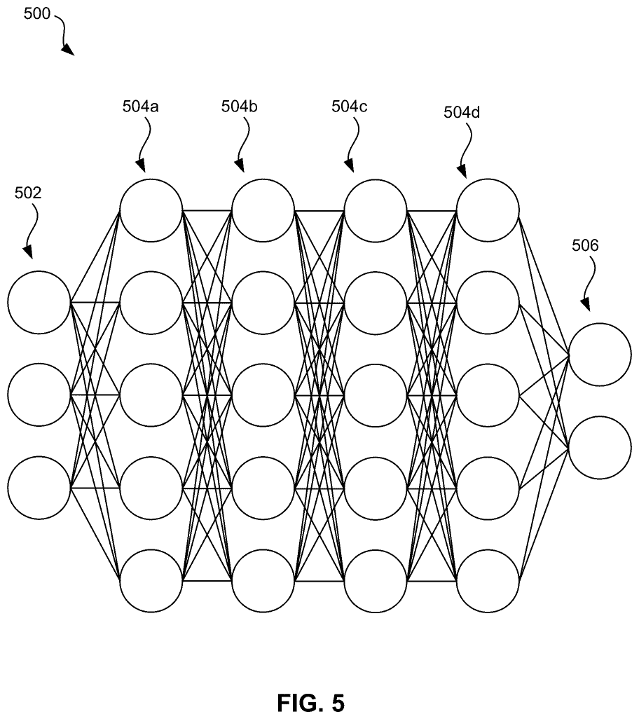

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ] \qquad ( 5 )$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )} \qquad ( 6 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 7 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( logx )} {e}^{{Σ}_{i} {f}_{i}^{d} ( {d}_{i} )} \qquad ( 8 )$$

where d represents one or more features of the independent variable x.

It will be appreciated that automated item recommendation and ranking, as disclosed herein, particularly for large platforms such as e-commerce network platforms, is only possible with the aid of computer-assisted machine-learning algorithms and techniques, such as the disclosed item recommendation model 224. In some embodiments, item recommendation and ranking processes including the trained item recommendation model 224 are used to perform operations that cannot practically be performed by a human, either mentally or with assistance. Such operations include, but not limited to, automated extraction of information of a plurality of items from an item database, identification of a plurality of item types of a category based on the extracted information, and selections of a set of item types based on themes of a plurality of themes of the category. In some situations, the item database stores information of millions of items, which cannot practically be processed by a human. It will be appreciated that a variety of item recommendation and ranking techniques can be used alone or in combination to further determine an ordered list of recommended items associated with the set of item types the category.

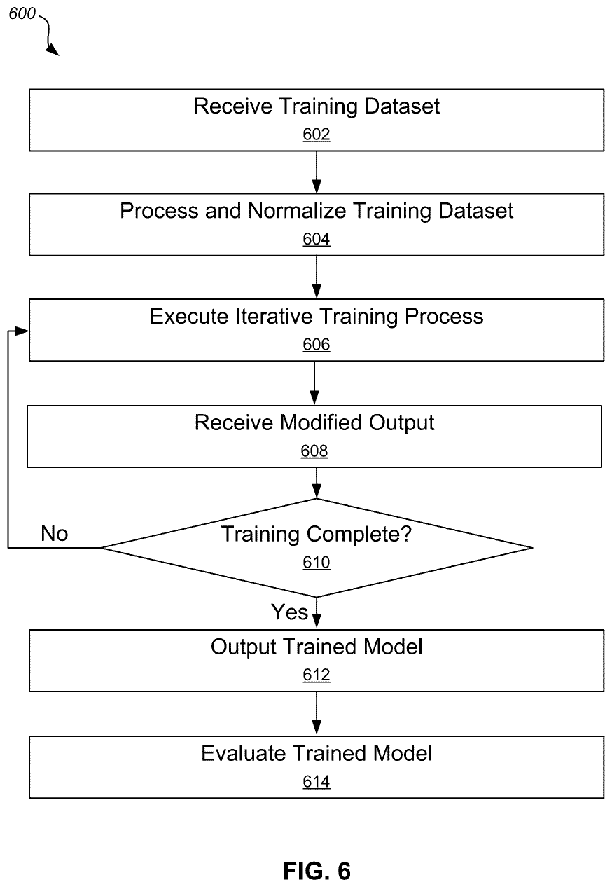

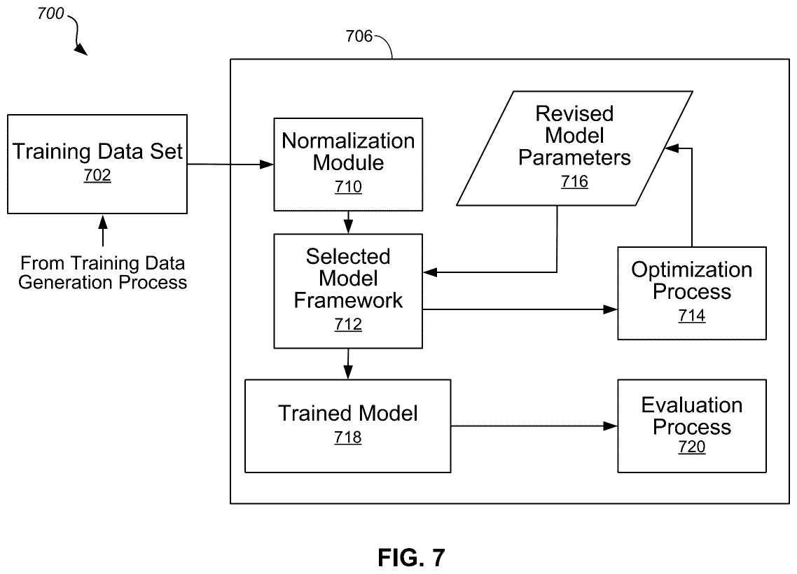

In some embodiments, an item ranking method can include and/or implement one or more trained models, such as a trained item recommendation model 224. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained item recommendation model 224 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) item recommendation model 224, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

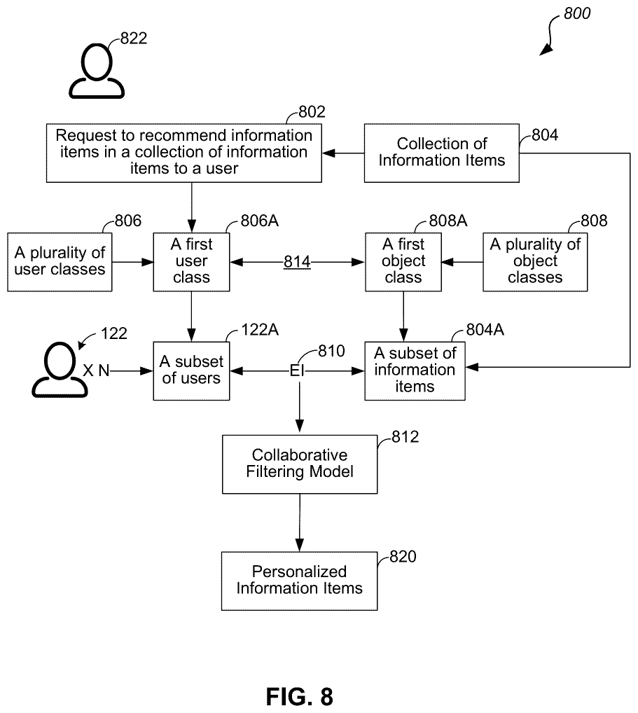

FIG. 8 is a flow diagram of an example process 800 for generating a set of personalized information items 820 using a collaborative filtering model, in accordance with some embodiments. The process 800 may be implemented by a system (e.g., including the recommendation computing device 102 and/or the cloud-based engine 121). The system may identify (e.g., obtain, receive, etc.) a request 802 for one or more personalized information items 820. In some embodiments, each information item 804 in a set (e.g., catalog) of information items corresponds to a respective product, object, or item and includes one or more of features, such as a title, short description, long description, product type taxonomy, shelf taxonomy, item attributes of the respective product, object, or item, etc. Examples of item attributes may include, but are not limited to, a dimension, a weight, a price, a material, etc. In some embodiments, the system enables execution of a network application, such as an online shopping application, via an Internet browser and/or a dedicated application on a client device (e.g., a user computing device 110, 112, or 114) associated with the user 112. A user interface of the network application may be displayed on a screen of the client device. The system may receive a user action on an actionable interface element displayed on the user interface and may generate the request 802 in response to the user action. In response to the request 802, the system may enable display of the one or more personalized information items 820 on the screen of the client device associated with the user 822.

The system may determine that a user 822 belongs to a first user class 806A of a plurality of user classes 806. The first user class 806A may have a predefined relationship 814 with a first object class 808A of one or more object classes 808. The system may identify, among a plurality of users 122, a subset of users 122A classified in the first user class 806A. The subset of users 122A may include the user 822 associated with the request 802. The system may identify, in the collection of information items 804, a subset of information items 804A classified in a first object class 808A. A database 116 may store engagement information 810 representative of engagement of the subset of users 122A of the first user class 806A with the subset of information items of the first object class 808A. the engagement information 810 may include historic transaction data concerning the subset of users 122A searching, buying, reviewing, and/or returning products associated with the subset of information items 804A. Such engagement information 810 of the subset of users 122A may be applied by a collaborative filtering model 812 to identify the one or more personalized information items 820. Stated another way, in accordance with engagement of other users of the same user class 806A with the subset of information items 804A, the system identifies one or more information items (e.g., personalized information items 820) that have a higher chance of engagement by the user 822 as compared to a remainder of the subset of information items 804A.

In some embodiments, the collection of information items 804 is associated with a large number (e.g., 40 million) of products and includes millions of information items stored in a database, such as database 116 illustrated in FIG. 1. The subset of users 122A of the first user class 806A may includes a first number (N₁) of users (e.g., >1000 users). The first object class 808A associated with the first user class 806A may include a second number (N₂) of information items (e.g., >1000 items) from which the personalized information items 820 are selected for the user 822. In some situations, each of the first number (N₁) and the second number (N₂) is greater than a respective threshold number N_{TH} (e.g., 100). In some embodiments, each item of the collection of information items 804 is classified in one or more object classes 808 (e.g., more than 2 classes), and each of the plurality of users 122 is classified in one or more user classes 806. This further increases the number of users 122A similar to the user 822 and their associated information items 804A. Given the large number of similar users 122A in the first user class 806A and the large number of products in the first object class 808A, it is not practical for a human to search the database 116 to identify, among the collection of information items 804, the one or more personalized information items 820 that are relevant to the user 822 in the context of engagement information 810 of the users 122A belonging to the same first user class 806A. The disclosed systems and methods include improvements to computer technology to allow for processing of the large amount of information in a useable time limit to improve recommendation and ranking results presented to the user 822.

In some embodiments, an implemented process comprises four stages including object understanding, user understanding, collaborative filtering, and nudges and recommendations. Information items in a collection of information items 804 may be analyzed by an ensemble of weak learners and classified into one or more of a plurality of object classes 808 (e.g., an animal type product such as a dog product, a cat product, a bird product, a horse product, etc.). Each weak learner may be derived from one or more partially and/or non-overlapping metadata sources. A trained user classification model (e.g., classifier 904 in FIG. 9) may be applied to determine a probability of a user 822 belonging each of a plurality of user classes 806 (e.g., one or more pet owner classes such as a dog owner, a cat owner, etc.). In accordance with a determination that the user 822 belongs to a first user class 806A, a collaborative filtering model 812 may determine one or more user embeddings for the subset of users 122 belong to the first user class 806 and item embeddings for the subset of information items 804A that are engaged with the subset of users 122. A user embedding for a user belonging to the user class 806A may be used together with the item embeddings of the information items embeddings for the subset of information items 804A to rank the information items and select the one or more personalized information items 820 based, at least in part, on the user and item embeddings. Interface elements representative of the one or more personalized information items 820 may be displayed on the client device associated with the user 822.

FIG. 9 is a block diagram of a system 900 for generating personalized information items 820 using a user object engine 920, in accordance with some embodiments. The system 900 includes a recommendation module 222 (FIG. 2) of a computing device 200 (e.g., a recommendation computing device 102 and/or a cloud-based engine 121 in FIG. 1) and one or more databases 906, 912, 914 (e.g., consolidated in a database 116 in FIG. 1). The recommendation module 222 further includes the user object engine 920 that may apply an item recommendation model 224 that includes an object classifier 902, a user classifier 904, and a collaborative filtering model 812. The item recommendation model 224 may be configured to identify one or more personalized information items 820 in a set of information items 804A for a user 822 of a first user class 806A based on engagement data of a set of similar users 122A of the first user class 806A with the set of information items 804A belonging to a first object class 808A associated with the first user class 806A. The object classifier 902 may obtain a collection of information items 804 (each of which corresponds to a respective product, object, or item, e.g., by extracting the collection of information items 804 from an object database 906) and associates a subset of information items 804A in the collection of information items 804 with a first object class 808A of a plurality of object classes 808. The user classifier 904 may determine that a user 822 belongs to a first user class 806A of a plurality of user classes 806 and identifies a subset of users 122A of the first user class 806A among a plurality of users 122. The user object engine 920 may apply the collaborative filtering model 812 to identify the one or more personalized information items 820 in the subset of information items 804A based on engagement information 810 of the subset of users 122A with the subset of information items 804A. Based on engagement of the subset of users 122A belonging to the first user class 806A with the subset of information items 804A, the collaborative filtering model 812 identifies information items in the subset of information items 804A that have a higher chance of engagement by the user 822 as compared to a remainder of the subset of information items 804A.

In some embodiments, each information item in the collection of information items 804 includes one or more features, such as, for example, a title, short description, long description, product type taxonomy, shelf taxonomy, item attributes of a respective product, object, or item, etc. In some embodiments, the collection of information items 804 are provided by a plurality of information sources that may generate different classifications of one or more information items 804. The importance or accuracy of each information source, for example, a title, short description, long description, product type taxonomy, shelf taxonomy, item attributes of a respective product, object, or item, etc., may be different. A novel ensemble learning model may be used to combine the classification scores of weak learner models learned from different information sources to determine a final classification score.

The system 900 operates in response to a request 802 to recommend one or more information items to a user 822. The request 802 may be received from the user 122 via a user interface, generated internally by the system 900 in accordance with a determination that a recommendation request condition is satisfied, and/or otherwise determined. After identifying the one or more personalized information items 820, the system 900 may enable display of the one or more personalized information items 820 on a screen of a client device associated with the user 822. In some embodiments, in accordance with a determination that the user 822 belongs to the first user class 806A having a predefined relationship 814 with the first object class 808A, the system 900 generates one or more nudges 908. Each nudge 908 uses design, information, and affordance elements to guide user behavior on an associated user application (e.g., an online shopping application). The one or more nudges 908 may be stored in a feedback database 912 for the user 822. Further, in some embodiments, in accordance with a determination that the user 822 belongs to the first user class 806A having a predefined relationship 814 with the first object class 808A, the system 900 enables a display of a signup page to invite the user 122 to create a profile 910 associated with the predefined relationship 814. Actionable information items representing the one or more information items 820 may be displayed on the signup page or concurrently with the signup page. The profile 910 may be stored in association with the user 822 in a user database 914.

In some embodiments, the user database 914 stores user information of a plurality of users 122 of a user application 218 (e.g., an online shopping application). The user object engine 920 of the system 900 may extract at least the user information of each of the subset of users 122A from the user database 914 and the user classifier 904 may be applied to classify each of the subset of users 122A to the first user class 806A based on the user information of the respective user 122A. In some embodiments, the user classifier 904 includes a user engagement extraction model 916 and a classification model 918. For each of the subset of users 122A, the user information of the respective user 122A may include, but is not limited to, a purchase history, a search history, a browsing history of the respective user 122A, etc. The user engagement extraction model 916 may be applied to generate a user engagement feature 928 based on the user information of the respective user 122A and the classification model 918 may be applied to determine that the respective user 122A belongs to the first user class 806A based on the user engagement feature 928. In some embodiments, the classification model 918 receives an output 922 of the object classifier 902, a feedback 924 associated with each user 122A, or both, and determines a user class of the respective user 122A based on the output 922 or feedback 924. For example, the classification model 918 may identify a subset of information items 804A of the first object class 808A associated with the first user class 806A based on the output 922 of the object classifier 902.

In some embodiments, the user classifier 904 generates a probability π_{u1,p} for the first user class 806A. In accordance with a determination that the probability π_{u1,p} for the first user class 806A is greater than a first user class threshold ϵ₁, the user object engine 920 may classify the respective user 122A to the first user class 806A. Additionally, in some embodiments, for each of the subset of users 122A, the user classifier 904 generates a probability π_{u2,p} for a second user class 806B. In accordance with a determination that the probability π_{u2,p} for the second user class 806B is greater than a second user class threshold ϵ₂, the user object engine 920 classifies the respective user 122A to the second user class 806B. A user 122A may belong to both the first user class 806A and the second user class 806B. For example, one of a subset of users 122A may be classified into two pet type classes (e.g., is both a dog owner and a horse owner). The classification model 918 may enable multi-label classification allowing a user 122A to be classified into more than one user class 806. For example, a user classifier 904 may include a sigmoid activation layer and may be trained based on a cross-entropy loss. A sigmoid activation ensures that the output of the layer varies between 0 to 1, and hence is a valid probability measure. A cross-entropy loss does not put a user exclusively in one of the classes. For example, having a high score on class “Dog owner” doesn't reduce the score for class “Cat owner” if we use a cross-entropy loss. Thus, the cross-entropy loss allows a user to be simultaneously in two or more classes with high probability.

In some embodiments, the first user class 806A is associated with the first object class 808A according to a predefined relationship 814. For example, the first user class 806A may be a dog owner and the first object class 808A may be a dog toy class. The subset of information items 804A belonging to the first object class 808A associated with the first user class 806A may be determined based on an output 922 (e.g., an object embedding) provided by the object classifier 902 and a user engagement feature 928 provided by the user engagement extraction model 916, which obtains historic information of searches, browsing, add-to-carts (ATCs), and transactions. In accordance with the subset of information items 804A and the subset of users 122A, corresponding engagement information 810 may be extracted from the user database 914.

In some embodiments, the engagement information 810 of the subset of users 122A includes, but is not limited to, a purchase history, a search history, a browsing history of each of the subset of users 122A, and/or any other suitable history. Based on the engagement information 810, the collaborative filtering model 812 may be applied to determine a user embedding 926 of each of the subset of users 822A. In some embodiments, a similarity level is determined between the user 822 and each of the subset of users 822A based on the user embeddings 926 of the subset of users 822A. The collaborative filtering model 812 may be trained to determine an object embedding 930 for each the subset of information items 804A in addition to the user embedding for each of the subset of users 822A. A loss function L may be applied to train the collaborative filtering model 812:

$$L = min {\sum }_{u , i} {{c}_{u , i} ( {p}_{u , i} - {x}_{u}^{T} {y}_{i} )}^{2} + λ f ( {x}_{u} , {y}_{i} )$$

where u and i are indexes referring to users of the subset of users 122A and objects associated with the subset of information items 804A, respectively, c_{u,i} is a confidence score, p_{u,i} is an engagement label associated with the engagement information 810 between the users 122A and the information items 804A, xᵤ is an associated user embedding 926, yᵢ is an associated object embedding 930, and λf(xᵤ, yᵢ) is a regularization term.

The subset of information items 804A may be ranked for the user 822 based on the similarity level between the user 822 and each of the subset of users 822A. For example, in some embodiments, each of the subset of information items 804A corresponds to a respective object. For each of the subset of information items 804A, a set of related users 122B has engaged (e.g., bought, reviewed) the respective object (as represented in the engagement information 810). The system 900 generates a weighted object number (e.g., W1, W2, W3, W4, and W5) for each of the set of related users 122B as a product of a total number of object times engaged by the related user 122B and the similarity level between the user 822 and the related user 122B. The system 900 may determine an accumulated object number as a sum of the weighted object numbers (e.g., W1-W5) of the set of related users 122B. The one or more personalized information items 820 are selected from the subset of information items 804A in accordance with a determination that the accumulated object numbers of the information items 820 are higher than those of a remainder of the subset of information items 804A for the user 822.

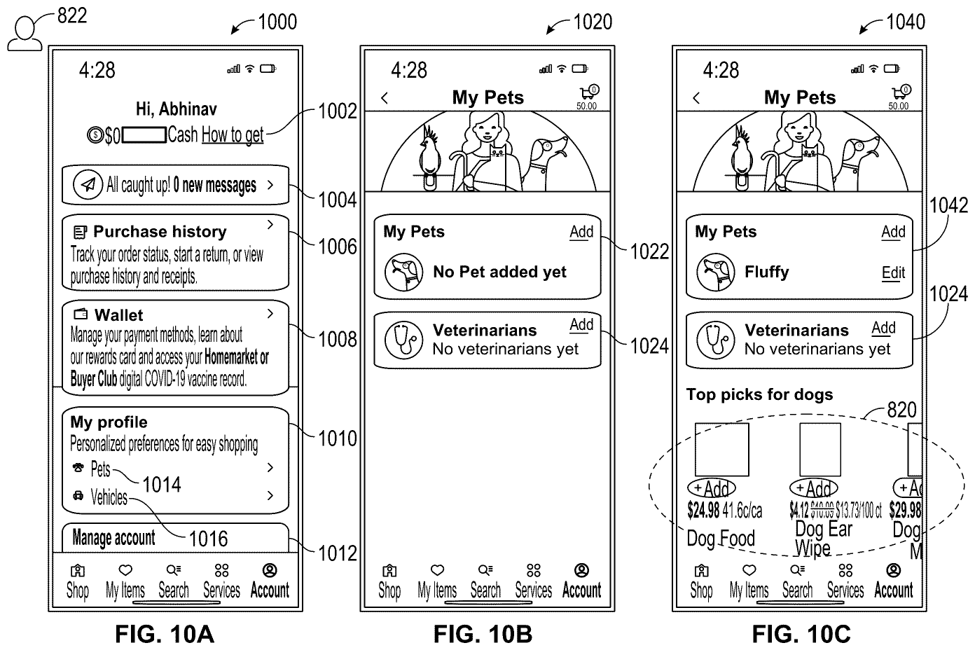

FIGS. 10A-10C are example user interfaces 1000, 1020, and 1040 of a user application 218 (e.g., an online shopping application), in accordance with some embodiments. A system 900 may execute the user application via an Internet browser, a dedicated application on a client device (e.g., one or more user computing devices 110, 112, 114 in FIG. 1) associated with a user 822, and/or any other suitable interface generation system. The user interfaces 1000, 1020, and 1040 of the user application are displayed on a screen of the client device for the user 822. Referring to FIG. 10A, in some embodiments, after the user 822 logs onto the user application, a home page is displayed for the user 822 on the user interface 1000. Actionable information items 1002, 1004, 1006, 1008, and 1010 may be displayed and include programmatically generated navigational shortcuts to one or more additional interface pages, such as a summary of cash interface, a message board interface, a purchase history interface, a digital wallet interface, and a profile interface, respectively. An account management menu 1012 may be displayed on the bottom of the user interface 1000 including one or more additional interface elements, such as navigational shortcuts to interface elements or pages labelled with “Shop,” “My Items,” “Search,” “Services,” and “Accounts.” In some embodiments, the system 900 enables a display of a signup page to invite the user 122 to create a profile 910, e.g., a pet profile and a vehicle profile, which may be linked via actionable information item 1014 and 1016 on the actionable information item 1010. The profile 910 may be stored in association with the user 822 in a user database 914 (FIG. 9).

Referring to FIG. 10B, in some embodiments, and in response to a user action on the actionable information item 1014 (FIG. 10A) linked to a pet profile, actionable information items 1022 and 1024 are displayed to prompt the user 822 to create a pet profile or select a veterinarian. Conversely, referring to FIG. 10C, in some embodiments, and in response to a user action on the actionable information item 1014 (FIG. 10A) linked to a pet profile, actionable information items 1042 and 1024 are displayed to prompt the user 822 to open an existing pet profile or select a veterinarian, respectively. In some embodiments, a dog profile linked to the actionable information item 1042 is created automatically based on the historic engagement data (e.g., a purchase history, a search history, and a browsing history) of the user 822. The user 822 may click the actionable information item 1042 to open the dog profile and continue to update the dog profile. In some embodiments, in response to the user action on the actionable information item 1014 of the user interface 1000 (FIG. 10A), a request 802 is generated to recommend the one or more information items 820, which are selected for the user 822 and displayed on the screen of the client device associated with the user 822. The one or more information items 820 are selected based on engagement of other users 122A of the same user class 806A with information items 804A in the associated object class 808A, and form a personalized carousel for interface elements associated with the object class 808A, thereby providing relevant, smooth, and personalized user experience for each individual user 822 efficiently.

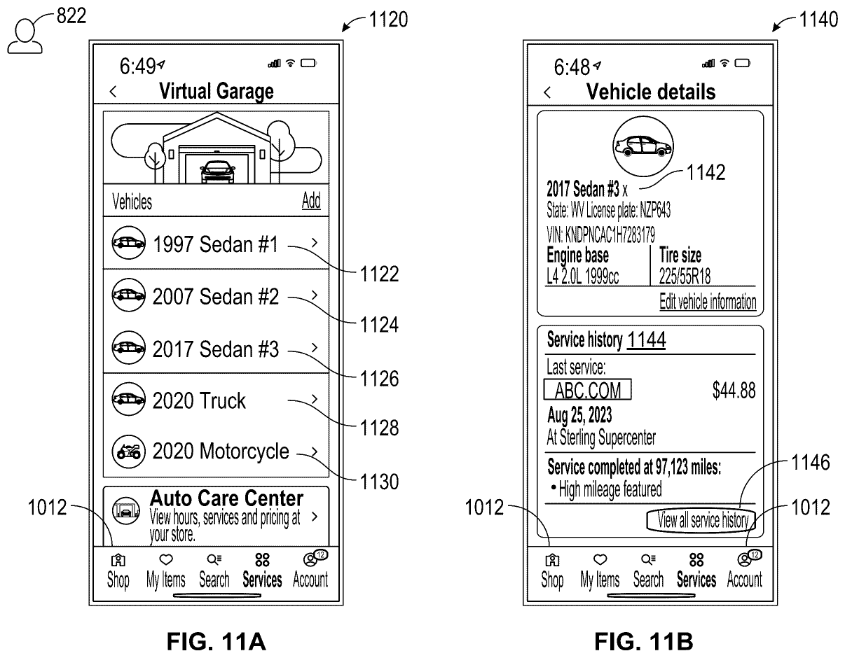

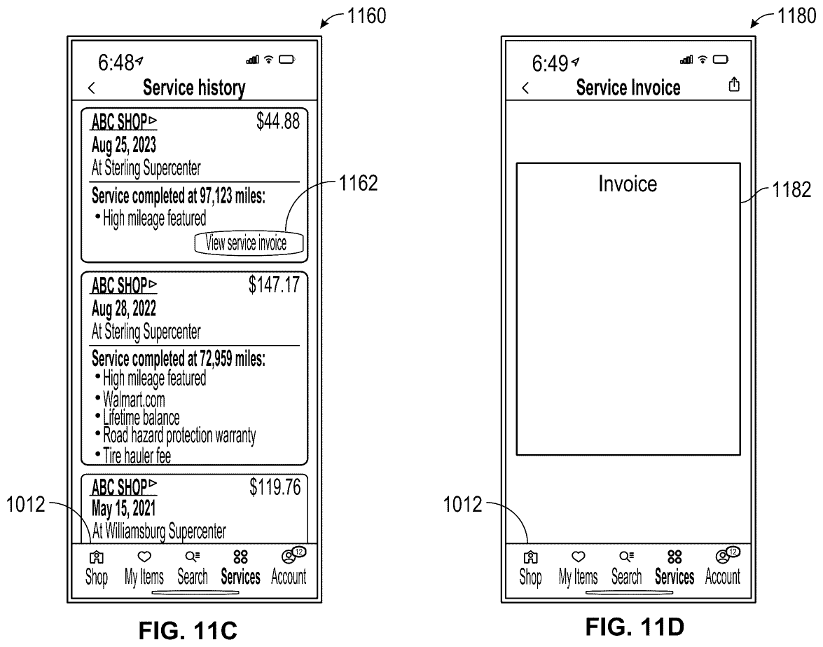

FIGS. 11A-11D are user interfaces 1120, 1140, 1160, and 1180 that present a vehicle profile for a user 822, in accordance with some embodiments. A system 900 executes a user application 218 via an Internet browser, a dedicated application on a client device (e.g., one or more user computing devices 110, 112, 114 in FIG. 1) associated with the user 822, and/or any other suitable interface generation system. The user interfaces 1120, 1140, 1160, and 1180 of the user application 218 may be displayed on a screen of the client device for the user 822. As explained above, in some embodiments (FIG. 10A), after the user 822 logs onto the user application 218, a home page is displayed for the user 822 on the user interface 1000. The user interface 1000 includes actionable information items 1002-1012, and the actionable information item 1010 further two additional actionable information items 1014 and 1014, which are linked to a pet profile and a vehicle profile.

Referring to FIG. 11A, in some embodiments, in response to a user action on the actionable information item 1016 (FIG. 10A) linked to the vehicle profile, actionable information items 1122-1130 are displayed to prompt the user 822 to create vehicle profiles for four vehicles (“1997 Sedan #1, 2007 Sedan #2, 2017 Sedan #3, and 2020 Truck) and a motorcycle (“2020 Motorcycle”). Referring to FIG. 11B, in some embodiments, in response to a user action on the actionable information item 1126 (FIG. 11A) linked to “2017 Sedan #3” on the user interface 1140, a vehicle profile is loaded and displayed to provide basic vehicle information 1142 (e.g., license plate number, engine base, tire size) and service history 1144 in a collapsed format. The user interface 1140 further includes a button 1146 (“View all service history”). Referring to FIG. 11C, in some embodiments, in response to a user action on the button 1146, a scrollable list of service histories are displayed on the user interface 1160. The user interface 1160 further includes a button 1162 (“View service invoice”). Referring to FIG. 11D, in some embodiments, in response to a user action on the button 1162, an invoice document 1182 is opened and displayed on the user interface 1180.

In some embodiments not shown here, other similar vehicle users belonging to the same user class as the user 822 are engaged with (e.g., purchased, reviewed, added into cart, searched for) information items associated with vehicle products and vehicle services. Based on these similar vehicle users' engagement information, the system recommends, ranks, and/or presents the one or more information items 820 that have a higher chance of being engaged by the user 822 than remaining information items in the subset of information items 804A. For example, the one or more information items 820 may be displayed above the account management menu 1012 on FIG. 11D. Although certain embodiments are illustrated herein with respect to particular profiles, e.g., pet profiles, vehicle profiles, etc., it will be appreciated that the disclosed systems and methods can be utilized to generate interfaces including any suitable profile related to any suitable classification of a user 822.

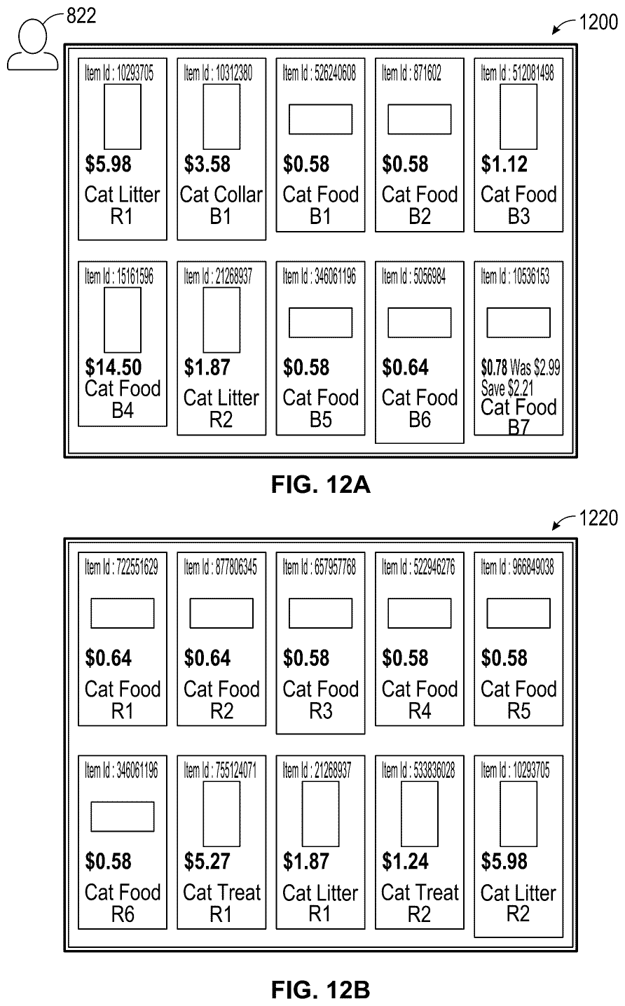

FIGS. 12A and 12B are user interfaces 1200,1220 that display a transaction history of a user 822 who is identified as a first class of pet owner and a set of recommended information items 820, in accordance with some embodiments, respectively. The transaction history of the user 822 displayed in the user interface 1200 is stored in associated with the user 822 in a user database 914, and is extracted and processed by a user classifier 904 to determine that the user 822 belongs to a first user class 806A corresponding to the first pet type owner. The personalized information items 820 are represented by interface elements that may or may not be interacted with by the user 822. the personalized information items 820 belong to a first object class 808A associated with the same first pet type and are selected based on engagement information of other similar users 122A (e.g., first pet type owners).

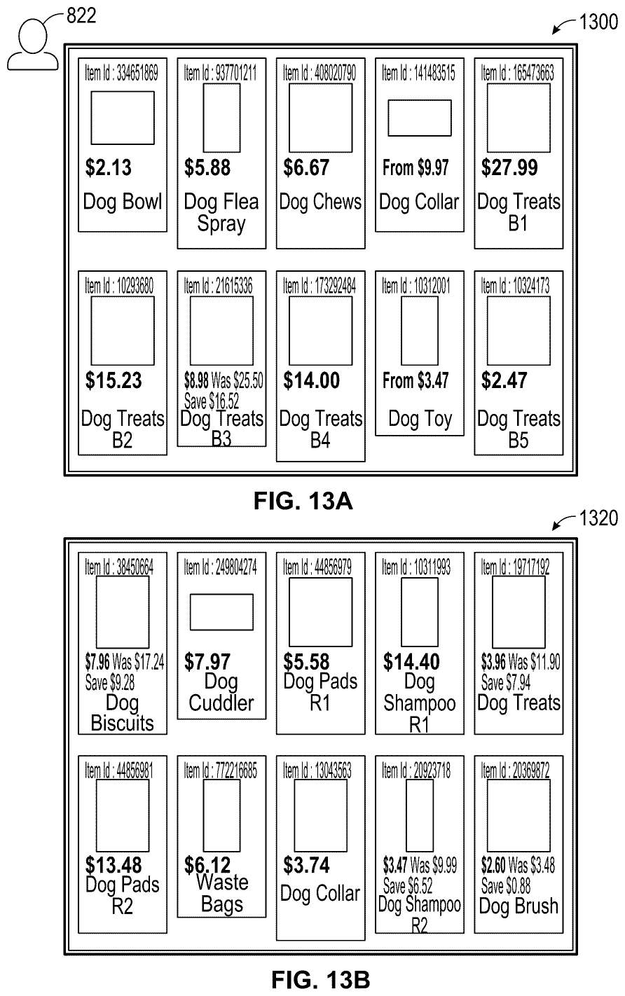

FIGS. 13A and 13B are user interfaces 1300, 1320 that display a transaction history of a user 822 who is identified as a second class of pet owner (e.g., a dog owner) and a set of recommended information items 820, in accordance with some embodiments, respectively. The transaction history of the user 822 displayed in the user interface 1300 is stored in associated with the user 822 in a user database 914, and is extracted and processed by a user classifier 904 to determine that the user 822 belongs to a first user class 806A corresponding to the dog owner. The information items 820 may or may not be bought or reviewed by the user 822. Rather, the information items 820 belong to a first object class 808A associated with dogs, and are selected and ranked based on engagement information of other similar users 122A (e.g., dog owners).

In some embodiments, in accordance with a predefined relationship 814, the first user class 806A and the first object class 808A are associated with a pet type (e.g., cat in FIGS. 12A and 12B, dog in FIGS. 13A and 13B) of a plurality of pet types (e.g., dog, cat, horse, bird). For each of the subset of users 122A classified to the first user class 806A, a respective probability π_{u,p} of being an owner of a pet of the pet type is greater than a first user class threshold e. For each of the subset of information items 804A classified to the first object class 808A, a respective probability of being bought for a pet of the pet type is greater than a first object class threshold. Further, in some embodiments, each of the collection of information items 804 is classified to one or more object classes 808, and each of the plurality of users 122 is classified to one or more user classes 806. In an example, an information item 804 is classified to two object classes 808. In another example, a user 122 is classified to two user classes 806.

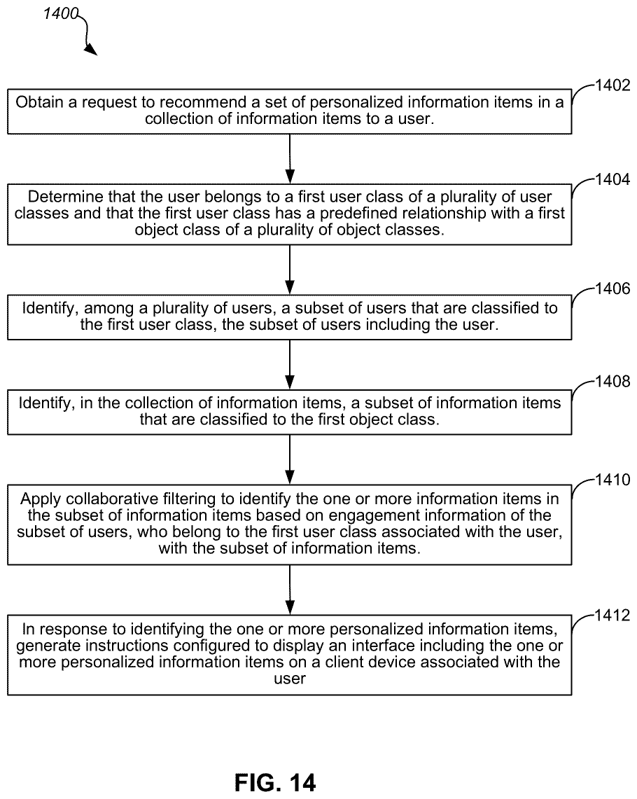

FIG. 14 is a flowchart illustrating an example method 1400 for recommendation, ranking, and/or presentation of information items, in accordance with some embodiments. Method 1400 may be governed by instructions that are stored in a non-transitory computer readable storage medium and that are executed by one or more processors of a system (e.g., a recommendation computing device 102). Each of the operations shown in FIG. 14 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1400 may be combined and/or the order of some operations may be changed.

Method 1400 may be performed by a system (e.g., the system 900 including a recommendation computing device 102) including a non-transitory memory having instructions stored thereon and at least one processor operatively coupled to the non-transitory memory. The at least one processor is configured to read and implement the instructions. In some embodiments, the system obtains (operation 1402) a request 802 to recommend a set of personalized information items 820 in a collection of information items 804 to a user 822. The system determines (operation 1404) that the user 822 belongs to a first user class 806A of a plurality of user classes 806 and that the first user class 806A has a predefined relationship 814 with a first object class 808A of a plurality of object classes 808. The system identifies (operation 1406) a subset of users 122A that are classified in the first user class 806A, and identifies (operation 1408) a subset of information items 804A that are classified to the first object class 808A in the collection of information items 804. The subset of users 122A may include the user 822. The system applies (operation 1410) a collaborative filtering model 812 to identify one or more personalized information items 820 from the subset of information items 804A based on engagement information 810 of the subset of users 122A. In response to identifying the one or more personalized information items 820, the system generates (operation 1412) instructions configured to display an interface including the one or more personalized information items on a client device associated with the user 822. Thus, in response to the request 802, the system enables display of the one or more personalized information items 820 on a screen of the client device associated with the user 822. In some embodiments, and in accordance with a collaborative filtering model 812, the system uses information regarding engagement of other users belonging to the user class with the subset of information items 804A to identify the one or more personalized information items 820 that have a higher chance of engagement by the user 822 than remaining information items.

In some embodiments, an object database 906 stores the collection of information items 804. The collection of information items 804 may include more than 10 million information items. The subset of users 122A may have a first number (N₁) of users and the subset of information items 804A may have a second number (N₂) of information items. Each of the first number (N₁) and the second number (N₂) may be greater than a respective threshold number N_{TH}.

In some embodiments, the system extracts, from an object database 906 (FIG. 9), each of the subset of information items 804A. The object database 906 stores the collection of information items 804. The system may apply an object classifier 902 (FIG. 9) to classify each of the subset of information items 804A to the first object class 808A among the plurality of object classes 808. Further, in some embodiments, each of the subset of information items 804A includes one or more features, such as a title, short description, long description, product type taxonomy, shelf taxonomy, item attributes of a respective object, etc.

In some embodiments, the system extracts, from a user database 914 (FIG. 9), user information of each of the subset of users 122A, the user database 914 storing user information of the plurality of users 122, and applies a user classifier 904 (FIG. 9) to classify each of the subset of users 122A to the first user class 806A based on the user information of the respective user. Further, in some embodiments, the user classifier 904 includes a user engagement extraction model 916 and a classification model 918. The system applies the user classifier 904 by: for each of the subset of users 122A, obtaining the user information of the respective user including one or more of: a purchase history, a search history, and a browsing history of the respective user, applying the user engagement extraction model 916 to generate a user engagement feature 928 (FIG. 9) based on the user information of the respective user, and applying the classification model 918 to determine the first user class 806A based on the user engagement feature.

Additionally, in some embodiments, the system applies the user classifier 904 by: for each of the subset of users 122A, generating a probability for the first user class 806A, and in accordance with a determination that the probability for the first user class 806A is greater than a first user class threshold, classifying the respective user to the first user class 806A. Additionally, in some embodiments, the system applies the user classifier 904 by: for each of the subset of users 122A, generating a probability for a second user class, and in accordance with a determination that the probability for the second user class 806B (FIG. 9) is greater than a second user class threshold, classifying the respective user to the second user class. The respective user belongs to both the first user class 806A and the second user class. Alternatively, in some embodiments, the system applies the user classifier by: for each of the subset of users 122A, generating a probability for a second user class, and in accordance with a determination that the probability for the second user class is not greater than a second user class threshold, determining that the respective user does not belong to the second user class.

In some embodiments, the engagement information 810 of the subset of users 122A includes one or more of: a purchase history, a search history, and a browsing history of each of the subset of users 122A. The system applies a collaborative filtering model 812 by determining a user embedding of each of the subset of users 122A based on the engagement information 810.

Further, in some embodiments, the system applies a collaborative filtering model 812 by determining a similarity level between the user 822 and each of the subset of users 122A based on the user embeddings of the subset of users 122A and ranking the subset of information items 804A for the user 822 based on the similarity level between the user 822 and each of the subset of users 122A. Additionally, in some embodiments, the system ranks the subset of information items 804A for the user 822 by: for each of the subset of information items 804A, determining that a set of related users 122B (FIG. 9) has engaged the respective object based on the engagement information 810, generating a weighted object number W1, W2, W3, W4, or W5 for each of the set of related users 122B as a product of a total number of object times engaged by the related user 122B and the similarity level between the user 822 and the related user 122B, and generating an accumulated object numbers as a sum of the weighted object number W1, W2, W3, W4, or W5 of the set of related users 122B. The respective information item corresponds to a respective object. The system determines that the accumulated object numbers of the one or more information items 820 are higher than those of a remainder of the subset of information items 804A for the user 822.

In some embodiments, in accordance with the predefined relationship 814, the first user class 806A and the first object class 808A are associated with a pet type of a plurality of pet types. For each of the subset of users 122A classified to the first user class 806A, a respective probability of being an owner of a pet of the pet type is greater than a first user class threshold. For each of the subset of information items 804A classified to the first object class 808A, a respective probability of being bought for a pet of the pet type is greater than a first object class threshold.

In some embodiments, the system enables execution of an online shopping application via one of an Internet browser and a dedicated application on the client device associated with the user 822. The system displays a user interface of the online shopping application on the screen, receives a user action on an actionable information item displayed on the user interface, and in response to the user action, generates the request 802 to recommend a set of personalized information items 820 to the user 822.

In some embodiments, in accordance with a determination that the user 822 belongs to the first user class 806A, the system enables a display of a signup page to invite the user 822 to create a profile associated with the predefined relationship 814. Actionable information items representing the one or more information items 820 are displayed on the signup page or concurrently with the signup page.

In some embodiments, each of the collection of information items 804 is classified to one or more object classes 808, and each of the plurality of users 122 is classified to one or more user classes 806.

Turning now to some example embodiments in the following clauses:

Clause 1. A system, comprising: a non-transitory memory having instructions stored thereon; and at least one processor operatively coupled to the non-transitory memory, and configured to read the instructions to: obtain (operation 1402) a request to recommend a set of personalized information items in a collection of information items to a user; determine (operation 1404) that the user belongs to a first user class of a plurality of user classes and that the first user class has a predefined relationship with a first object class of a plurality of object classes; identify (operation 1406), among a plurality of users, a subset of users that are classified to the first user class, the subset of users including the user; identify (operation 1408), in the collection of information items, a subset of information items that are classified to the first object class; apply (operation 1410) a collaborative filtering model to identify one or more personalized information items in the subset of information items based on engagement information of the subset of users, who belong to the first user class associated with the user, with the subset of information items; and in response to identifying the one or more personalized information items, generate (operation 1412) instructions configured to display an interface including the one or more personalized information items on a client device associated with the user.

Clause 2. The system of clause 1, further comprising: an object database storing the collection of information items, wherein the collection of information items includes more than 10 million information items, and wherein the subset of users has a first number (N₁) of users, and the subset of information items has a second number (N₂) of information items, where each of the first number (N₁) and the second number (N₂) is greater than a respective threshold number N_{TH}.

Clause 3. The system of clause 1 or 2, further comprising instructions to: extract, from an object database, each of the subset of information items, the object database storing the collection of information items; and apply an object classifier to classify each of the subset of information items to the first object class among the plurality of object classes.

Clause 4. The system of clause 3, wherein each of the subset of information items includes one or more of: title, short description, long description, product type taxonomy, shelf taxonomy, and item attributes of a respective object.

Clause 5. The system of any of clauses 1-4, further comprising instructions to: extract, from a user database, user information of each of the subset of users, the user database storing user information of the plurality of users; and apply a user classifier to classify each of the subset of users to the first user class based on the user information of the respective user.

Clause 6. The system of clause 5, wherein the user classifier includes a user engagement extraction model and a classification model, applying the user classifier further comprising, for each of the subset of users: obtaining the user information of the respective user including one or more of: a purchase history, a search history, and a browsing history of the respective user; applying the user engagement extraction model to generate a user engagement feature based on the user information of the respective user; and applying the classification model to determine the first user class based on the user engagement feature.

Clause 7. The system of clause 5 or 6, applying the user classifier further comprising, for each of the subset of users: generating a probability for the first user class; and in accordance with a determination that the probability for the first user class is greater than a first user class threshold, classifying the respective user to the first user class.

Clause 8. The system of clause 7, applying the user classifier further comprising, for each of the subset of users: generating a probability for a second user class; and in accordance with a determination that the probability for the second user class is greater than a second user class threshold, classifying the respective user to the second user class, the respective user belonging to both the first user class and the second user class.

Clause 9. The system of clause 7 or 8, applying the user classifier further comprising, for each of the subset of users: generating a probability for a second user class; and in accordance with a determination that the probability for the second user class is not greater than a second user class threshold, determining that the respective user does not belong to the second user class.

Clause 10. The system of any of clauses 1-9, wherein the engagement information of the subset of users includes one or more of: a purchase history, a search history, and a browsing history of each of the subset of users, applying the collaborative filtering model further comprising: based on the engagement information, determining a user embedding of each of the subset of users.

Clause 11. The system of clause 10, applying the collaborative filtering model further comprising: determining a similarity level between the user and each of the subset of users based on the user embeddings of the subset of users; and ranking the subset of information items for the user based on the similarity level between the user and each of the subset of users.

Clause 12. The system of clause 11, ranking the subset of information items for the user further comprising: for each of the subset of information items, wherein the respective information item corresponds to a respective object: determining that a set of related users has engaged the respective object based on the engagement information; generating a weighted object number for each of the set of related users as a product of a total number of object times engaged by the related user and the similarity level between the user and the related user; and generating an accumulated object numbers as a sum of the weighted object number of the set of related users; and determining that the accumulated object numbers of the one or more personalized information items are higher than those of a remainder of the subset of information items for the user.

Clause 13. The system of any of clauses 1-12, wherein: in accordance with the predefined relationship, the first user class and the first object class are associated with a pet type of a plurality of pet types; for each of the subset of users classified to the first user class, a respective probability of being an owner of a pet of the pet type is greater than a first user class threshold; and for each of the subset of information items classified to the first object class, a respective probability of being bought for a pet of the pet type is greater than a first object class threshold.

Clause 14. The system of any of clauses 1-13, further comprising instructions to: enable execution of an online shopping application via one of an Internet browser and a dedicated application on the client device associated with the user, including: displaying a user interface of the online shopping application on the screen; receiving a user action on an actionable information item displayed on the user interface; and in response to the user action, generating the request to recommend one or more personalized information items to the user.

Clause 15. The system of any of clauses 1-14, further comprising instructions to: in accordance with a determination that the user belongs to the first user class, enable a display of a signup page to invite the user to create a profile associated with the predefined relationship, wherein actionable information items representing the one or more personalized information items are displayed on the signup page or concurrently with the signup page.

Clause 16. The system of any of clauses 1-15, wherein each of the collection of information items is classified to one or more object classes, and each of the plurality of users is classified to one or more user classes.

Clause 17. A non-transitory computer-readable storage medium, having instructions stored thereon, which when executed by one or more processors cause the processors to implement the instructions, and the instructions including instructions in the system in any of clauses 1-16.

Clause 18. A method, comprising: at a system including a non-transitory memory having instructions stored thereon and at least one processor operatively coupled to the non-transitory memory and configured to read the instructions: implementing operations for which the system in any of clauses 1-16 includes instructions.

It should be understood that the particular order in which the operations in FIG. 14 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-13 are also applicable in an analogous manner to method 1400 described above with respect to FIG. 14. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, the processor configured to read the instructions to:
obtain a request to select a set of personalized information items from a collection of information items to a user;
classify the user in a first user class of a plurality of user classes, wherein the first user class has a predefined relationship with a first object class of a plurality of object classes;
identify, among a plurality of users, a subset of users that are classified in the first user class;
identify, in the collection of information items, a subset of information items that are classified in the first object class;
identify the one or more personalized information items utilizing a collaborative filtering model, wherein the collaborative filtering model is configured to receive an input including engagement information of the subset of users and the subset of information items; and
in response to identifying the one or more personalized information items, generate instructions configured to display an interface including the one or more personalized information items on a client device associated with the user.

2. The system of claim 1, further comprising:
an object database storing the collection of information items, wherein the collection of information items includes more than 10 million information items, and wherein the subset of users has a first number (N₁) of users, and the subset of information items has a second number (N₂) of information items, where each of the first number (N₁) and the second number (N₂) is greater than a respective threshold number N_{TH}.

3. The system of claim 1, further comprising instructions to:
extract, from an object database, each of the subset of information items, the object database storing the collection of information items; and
apply an object classifier to classify each of the subset of information items to the first object class among the plurality of object classes.

4. The system of claim 3, wherein each of the subset of information items includes one or more of: title, short description, long description, product type taxonomy, shelf taxonomy, and item attributes of a respective object.

5. The system of claim 1, further comprising instructions to:
extract, from a user database, user information of each of the subset of users, the user database storing user information of the plurality of users; and
apply a user classifier to classify each of the subset of users to the first user class based on the user information of the respective user.

6. The system of claim 5, wherein the user classifier includes a user engagement extraction model and a classification model, applying the user classifier further comprising, for each of the subset of users:
obtaining the user information of the respective user including one or more of: a purchase history, a search history, and a browsing history of the respective user;
applying the user engagement extraction model to generate a user engagement feature based on the user information of the respective user; and
applying the classification model to determine the first user class based on the user engagement feature.

7. The system of claim 5, applying the user classifier further comprising, for each of the subset of users:
generating a probability for the first user class; and
in accordance with a determination that the probability for the first user class is greater than a first user class threshold, classifying the respective user to the first user class.

8. The system of claim 7, applying the user classifier further comprising, for each of the subset of users:
generating a probability for a second user class; and
in accordance with a determination that the probability for the second user class is greater than a second user class threshold, classifying the respective user to the second user class, the respective user belonging to both the first user class and the second user class.

9. The system of claim 7, applying the user classifier further comprising, for each of the subset of users:
generating a probability for a second user class; and
in accordance with a determination that the probability for the second user class is not greater than a second user class threshold, determining that the respective user does not belong to the second user class.

10. A non-transitory computer-readable storage medium, having instructions stored thereon, which when executed by one or more processors cause the processors to:
obtain a request to select a set of personalized information items from a collection of information items to a user;
classify the user in a first user class of a plurality of user classes, wherein the first user class has a predefined relationship with a first object class of a plurality of object classes;
identify, among a plurality of users, a subset of users that are classified in the first user class;
identify, in the collection of information items, a subset of information items that are classified in the first object class;
identify the one or more personalized information items utilizing a collaborative filtering model, wherein the collaborative filtering model is configured to receive an input including engagement information of the subset of users and the subset of information items; and
in response to identifying the one or more personalized information items, generate instructions configured to display an interface including the one or more personalized information items on a client device associated with the user.

11. The non-transitory computer-readable storage medium of claim 10, wherein the engagement information of the subset of users includes one or more of: a purchase history, a search history, and a browsing history of each of the subset of users, applying the collaborative filtering model further comprising:
based on the engagement information, determining a user embedding of each of the subset of users.

12. The non-transitory computer-readable storage medium of claim 11, applying the collaborative filtering model further comprising:
determining a similarity level between the user and each of the subset of users based on the user embeddings of the subset of users; and
ranking the subset of information items for the user based on the similarity level between the user and each of the subset of users.

13. The non-transitory computer-readable storage medium of claim 12, ranking the subset of information items for the user further comprising:
for each of the subset of information items, wherein the respective information item corresponds to a respective object:
determining that a set of related users has engaged the respective object based on the engagement information;
generating a weighted object number for each of the set of related users as a product of a total number of object times engaged by the related user and the similarity level between the user and the related user; and
generating an accumulated object numbers as a sum of the weighted object number of the set of related users; and determining that the accumulated object numbers of the one or more personalized information items are higher than those of a remainder of the subset of information items for the user.

14. The non-transitory computer-readable storage medium of claim 10, wherein:
in accordance with the predefined relationship, the first user class and the first object class are associated with a pet type of a plurality of pet types;
for each of the subset of users classified to the first user class, a respective probability of being an owner of a pet of the pet type is greater than a first user class threshold; and
for each of the subset of information items classified to the first object class, a respective probability of being bought for a pet of the pet type is greater than a first object class threshold.

15. The non-transitory computer-readable storage medium of claim 10, further comprising instructions to:
enable execution of an online shopping application via one of an Internet browser and a dedicated application on the client device associated with the user, including:
displaying a user interface of the online shopping application on a screen;
receiving a user action on an actionable information item displayed on the user interface; and
in response to the user action, generating the request to recommend one or more personalized information items to the user.

16. A method, comprising:
at a system including a non-transitory memory having instructions stored thereon and at least one processor operatively coupled to the non-transitory memory and configured to read the instructions:
obtaining a request to select a set of personalized information items from a collection of information items to a user;
classifying the user in a first user class of a plurality of user classes, wherein the first user class has a predefined relationship with a first object class of a plurality of object classes;
identifying, among a plurality of users, a subset of users that are classified in the first user class;
identifying, in the collection of information items, a subset of information items that are classified in the first object class;
identifying the one or more personalized information items utilizing a collaborative filtering model, wherein the collaborative filtering model is configured to receive an input including engagement information of the subset of users and the subset of information items; and
in response to identifying the one or more personalized information items, generating instructions configured to display an interface including the one or more personalized information items on a client device associated with the user.

17. The method of claim 16, further comprising:
in accordance with a determination that the user belongs to the first user class, enabling a display of a signup page to invite the user to create a profile associated with the predefined relationship, wherein actionable information items representing the one or more personalized information items are displayed on the signup page or concurrently with the signup page.

18. The method of claim 16, wherein each of the collection of information items is classified to one or more object classes, and each of the plurality of users is classified to one or more user classes.

19. The method of claim 16, further comprising:
storing in an object database the collection of information items, wherein the collection of information items includes more than 10 million information items, and wherein the subset of users has a first number (N₁) of users, and the subset of information items has a second number (N₂) of information items, where each of the first number (N₁) and the second number (N₂) is greater than a respective threshold number N_{TH}.

20. The method of claim 16, further comprising:
extracting, from an object database, each of the subset of information items, the object database storing the collection of information items; and
applying an object classifier to classify each of the subset of information items to the first object class among the plurality of object classes.
